(19) United States
(12) Patent Application Publication
(10) Pub. No.: US 2025/0228338 A1
(43) Pub. Date: Jul. 17, 2025

(54) Dissimilar material joining via interlocking metasurfaces

(71) Applicant: National Technology & Engineering Solutions of Sandia, LLC, Albuquerque, NM (US)

(72) Inventors: Benjamin Young, Albuquerque, NM (US); Philip James Noell, Albuquerque, NM (US); Benjamin James Elbrecht, Clemson, SC (US); Brad Lee Boyce, Albuquerque, NM (US)

(21) Appl. No.: 19/059,376

(22) Filed: Feb. 21, 2025

Related U.S. Application Data
(63) Continuation-in-part of application No. 17/888,846, filed on Aug. 16, 2022.

(51) Int. Cl. A44B 18/00

(52) U.S. Cl. CPC A44B 18/0061; A44B 18/0057

(57) ABSTRACT

The integration of dissimilar materials poses a significant challenge in engineering, necessitating innovative solutions for robust and reliable joining. Interlocking metasurfaces (ILMs) are a new joining technology comprising arrays of autogenous features patterned across two surfaces that interlock to form robust structural joints. The present invention is directed to optimizing the tensile performance of ILM joints formed between dissimilar materials. Parametric optimization can be used to identify optimal unit cell geometries for maximal yield strength. The invention enables the design of stronger ILM joints between dissimilar materials, thereby making ILMs a versatile and effective joining technology in diverse engineering applications.

### CROSS-REFERENCE TO RELATED APPLICATION

This application is a continuation-in-part of U.S. application Ser. No. 17/888,846, filed Aug. 16, 2022, which is incorporated herein by reference.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### STATEMENT REGARDING PRIOR DISCLOSURES BY THE INVENTOR OR A JOINT INVENTOR

The following disclosure is submitted under 35 U.S.C. 102 (b) (1) (A): B. Elbrecht, B. Young, B. Clark, and P. Noell, “Dissimilar Material Joining via Interlocking Metasurfaces,” Experimental Mechanics, published online 10 Dec. 2024. The subject matter of this disclosure was conceived of or invented by the inventors named in this application.

### BACKGROUND OF THE INVENTION

Virtually all engineering designs use multiple materials to meet design intentions, often presenting significant challenges when joining dissimilar materials. Common structural joining technologies, e.g. welding, struggle to join common material systems such as steel and aluminum. See M. Pouranvari, Mater. Sci. Technol. 33 (15), 1705 (2017); and J. Schneider and R. Radzilowski, JOM 66 (10), 2123 (2014). Adhesives can join many materials but are generally weaker than welds or bolts and rapidly degrade at elevated temperatures. See Y. Wei et al., Compos. Part B: Eng. 276, 111225 (2024). Given the metallurgical and chemical challenges of welding, brazing, or adhesively bonding dissimilar materials, threaded fasteners are often the only viable technology. Threaded fasteners can join dissimilar materials, but this approach generally adds significant stress concentrations, mass, volume, and common failure points, all of which are drawbacks in many applications. See D. Croccolo et al., Metals 13 (10), 1708 (2023); and G. Cloud, Exp. Mech. 53, 1073 (2013). Further, some designs are not compatible with bolts due to tight clearances or stress from thermal expansion. See H. Liang et al., Chin. J. Aeronaut. 31 (8), 1728 (2018). Applications requiring the joining of multiple components with multiple materials and restricted structural geometries further complicates joint designs, e.g. aerospace airframes and fuselages, which often require non-standard joining techniques. See A. Sellito et al., Appl. Sci. 10 (5), 1880 (2020).

Interlocking metasurfaces (ILMs), a new type of joining technology, consist of arrays of autogenous features patterned across a surface that constrain relative motion between two bodies by interlocking with each other. The mechanical properties of ILMs are controlled by a combination of factors, including material, unit cell topology, unit cell interactions, and the number of interacting unit cells. See O. Bolmin et al., J. Mater. Sci. 58 (1), 411 (2023); and B. Young et al., Mater. Design 227, 111798 (2023). As ILMs are composed of the materials that constitute the joint, stronger and tougher materials will enhance the mechanical properties of the joint. Previous studies by Bolmin et al., Young et al., and Brown et al. showed that ILMs can achieve joint tensile and shear strengths of 30-40% of the substrate material, comparable to bolted joints. See O. Bolmin et al., J. Mater. Sci. 58 (1), 411 (2023); B. Young et al., Mater. Design 227, 111798 (2023); and N. K. Brown et al., Mater. Design 233, 112272 (2023). Brown et al. demonstrated both parametric- and genetic algorithm-based optimization schemes to increase the strength of ILM arrays in selected loading conditions by altering the unit cell geometry. See N. K. Brown et al., Mater. Design 233, 112272 (2023). Symmetric geometries were used to study the effects of each parameter on joint strength; however, this does not take full advantage of the disparate properties of dissimilar materials. See O. Bolmin et al., J. Mater. Sci. 58 (1), 411 (2023); B. Young et al., Mater. Design 227, 111798 (2023); and N. K. Brown et al., Mater. Design 233, 112272 (2023).

### SUMMARY OF THE INVENTION

The present invention is directed to ILMs, comprising a first metasurface of a first material having a first array of mechanically interlocking surface features that mate with a second metasurface of a second material having a second array of mechanically interlocking surface features. The ILMs can be configured such that the first and second materials reach their respective yield stresses at the same time when a tensile load is applied to the ILMs. At least one of the first or second metasurfaces can comprise a polymer, ceramic, or metal.

ILMs can join dissimilar materials with no loss in joint yield strength compared to joints composed solely of the weaker of the two constitutive materials. In particular, symmetric unit cell geometries enable ILMs to form joints that are stronger than single-material ILMs made of the weaker constitutive material. Both the tensile and flexural properties of the constitutive materials play significant roles in the mechanical performance of ILM joints. ILMs can be a versatile and robust solution for joining dissimilar materials in various engineering contexts, from astronautics to lightweight structural designs.

### BRIEF DESCRIPTION OF THE DRAWINGS

The detailed description will refer to the following drawings, wherein like elements are referred to by like numbers.

FIG. 1 is a schematic illustration of a sliding T-slot ILM.

FIG. 2a is an illustration of a dimensioned ILM geometry for experimental testing with the stem thicknesses, t_{VW} and t₈₄₃₀, marked as the variable dimension. FIG. 2b shows a T-slot with stem, transition, and head sections marked to identify fracture locations. The virtual strain gage (VSG) placement used in experimental testing is also shown on A and B sides. The depth dimension of 5.2 mm is normal to the page.

FIG. 3 shows an optimized geometry output from a FEA optimizer with dimensions added. The stem thicknesses, t_{VW} and t₈₄₃₀, are marked as the optimized parameters.

FIG. 4 is a graph of optimization data showing the stress ratio for each material and the objective, the stress ratio difference, calculated by Eqn. (2). The experimentally tested ILM geometries are also marked to provide landmarks on the objective value curve.

FIG. 5a is a graph of stress-strain curves for the VW reference ILM. FIG. 5b is a graph of stress-strain curves for the 8430 reference ILM.

FIGS. 6a-6e are graphs of stress-strain curves of ILMs joining dissimilar materials with stem thicknesses varied. The geometries tested were 6:1 VW: 8430 (FIG. 6a), 2.85:1 VW: 8430 (FIG. 6b), 1:1 VW: 8430 (FIG. 6c), 1:2.85 VW: 8430 (FIGS. 6d), and 1:6 VW: 8430 (FIG. 6e).

FIG. 7 is a graph of mean stress-strain curves of all tested ILM geometries with a minimum of five tension tests for each ILM geometry.

FIG. 8 is a summary plot of the joint yield stress of all ILM geometries normalized to the 8430 reference ILM.

FIG. 9 is a summary plot of the UTS of all ILM geometries normalized to the 8430 reference ILM.

FIGS. 10a-10g show in-situ images of all ILM geometries. The geometries are organized into rows (a-g) and columns (i-iii) to organize the test status into undeformed (i), deformed before fracture (ii), and post-fracture (iii) categories. Colors have been added to clarify material of each ILM.

FIG. 11a shows a summary of angular deflection measurements. FIG. 11b is a diagram of measurement method and landmarks.

### DETAILED DESCRIPTION OF THE INVENTION

The invention is directed to the joining of interlocking metasurfaces (ILMs) comprising dissimilar materials. When joining dissimilar materials, optimizing the topology of ILM unit cells can leverage the properties of dissimilar materials, resulting in joints that are stronger than those made purely from the weaker material. The yield strength of a dissimilar material joint can be maximized by adjusting the topology of unit cells on both sides of the joint. This can be achieved by designing asymmetric geometries of the unit cells in both materials, ensuring simultaneous yielding.

As will be described below, a variety of novel ILMs are enabled by both conventional and additive manufacturing (AM) techniques. While the examples herein focus on a specific ILMs manufactured by a few selected AM printing processes, ILMs can be manufactured in a variety of AM processes and in a broad range of materials, ranging from microscale polymers to ceramics to metals. For example, three AM manufacturing processes that can be used to print ILMs include polyjet, multiphoton lithography, and laser powder bed fusion (LPBF).

A wide variety of ILM design and feature options are possible with the present invention. Some exemplary ILMs are described in U.S. Pat. Appl. Pub. No. US 2024/0057729 A1, which is incorporated herein by reference. ILMs with T-shaped and arrow-like features described therein are very simple and can be easily adapted to various surfaces to yield a palette of ILM solutions. Variations of the T-shaped design including sliding T-slot and snapping T-slot features. Variations of the arrow-like design include split arrowhead and locked split arrowhead features. In addition to flat (planar) surfaces, the mechanically interlocking surface features can be fabricated on non-planar surfaces in a variety of surface features and patterns.

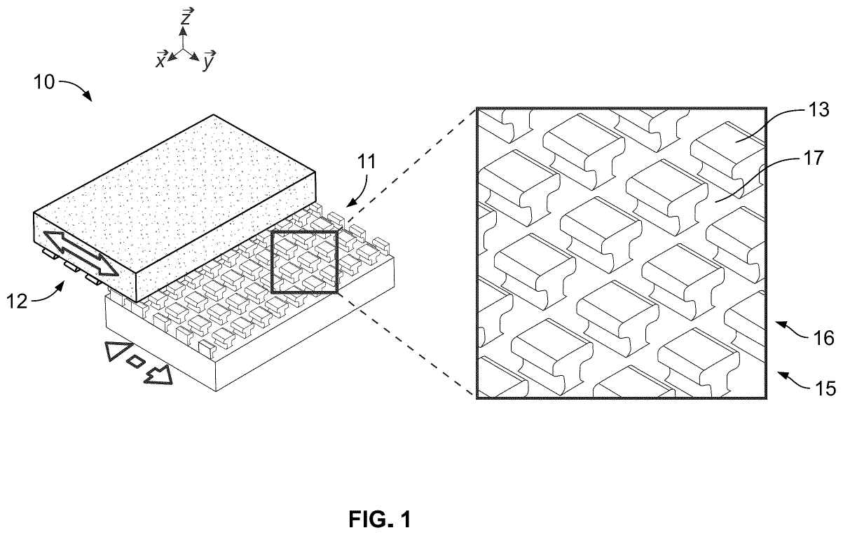

One exemplary ILM 10, shown in FIG. 1, is based on interlocking T-shaped features 13 that comprise identical first and second mating metasurfaces 11 and 12. This exemplary ILM is referred to as a “sliding T-slot”. The arrayed T features 13 are spaced apart from each other in the \vec{x} direction, thereby forming slots 15 in the \vec{y} direction. They form rows 16 of parallel T features that are spaced apart in the \vec{y} direction. The first T-slot metasurface 11 is engaged by a sliding action of the mating second metasurface 12 in the T-slots 15 along the longitudinal engagement direction (\vec{y}), parallel to the supporting surface 17. Depending on the initial position of the mating T features with respect one another, one or multiple parallel rows of T features can be connected. This T-slot ILM is symmetric (i.e., has geometrically identical mating surfaces) and has colinear engagement and disengagement directions (\vec{y}). Once engaged, the ILMs are maintained in a locked position in the transverse (\vec{x}) and vertical (\vec{z}) directions by mechanical interference between adjacent T features. The joint strength is determined by the tensile force in the \vec{z} direction required to separate the interlocking metasurfaces. The mating metasurfaces can be intentionally disengaged by sliding the mating metasurfaces past each other along the \vec{y} direction. However, the \vec{y} direction can be considered as a weak direction: for the sliding T-slot ILM, nothing but friction prevents unintentional disengagement in the y direction.

As an example, a pedagogical unit cell of the T-slot was tested. See O. Bolmin et al., J. Mater. Sci. 58 (1), 411 (2023); B. Young et al., Mater. Design 227, 111798 (2023); N. K. Brown et al., Mater. Design 233, 112272 (2023); and B. Young et al., Adv. Eng. Mater. 26, 2400150 (2024). Parametric optimization (PO) was used to design optimized unit cells and evaluated their performance against other geometries. PO iteratively modifies the geometric dimensions of an initial design to achieve optimal objectives while adhering to constraints. See M. Fazelpour and J. D. Summers, “A Comparison of Design Approaches to Meso-Structure Development,” ASME 2013 International Design Engineering Technical Conferences and Computers and Information in Engineering Conference, (2013). PO proves to be an efficient and robust optimization technique, provided that an initial geometrically-parameterized design is available, and the objective and constraint functions are continuous and differentiable. See G. A. Garcia et al., J. Electron. Packag. 144 (4), 041004 (2022); A. G. Gillies and R. S. Fearing, J. Micromech. Microeng. 20 (10), 105011 (2010); R. Prasad et al., “Design, fabrication, and characterization of single crystal silicon latching snap fasteners for micro assembly,” ASME Int. Mech Eng. Congress and Exposition (IMECE '95), 1995; and K. Svanberg, Int. J. Numer. Methods Eng. 24 (2), 359 (2005). Various analytical tools can be employed for this process, including partial differential equation solvers, finite element analysis (FEA), analytical equations, and models based on empirical data. See A. Alla et al., Adv. Comput. Math. 45 (3), 1221 (2019); A. G. Gillies and R. S. Fearing, J. Micromech. Microeng. 20 (10), 105011 (2010); A. Rajeev et al., J. Manuf. Process. 79, 35 (2022); I. A. Fotiou et al., “An algebraic geometry approach to nonlinear parametric optimization in control”, 2006 American Control Conference, IEEE, (2006); and W. Zhu et al., Appl. Sci. 12 (3), 1633 (2022). These are used to assess design performance, compare it to the objectives, and adjust geometric parameters accordingly. A gradient-based optimization algorithm was used herein to alter the geometric parameters based solely on the isotropic yield properties of the materials considered.

### Materials

The materials used were VeroPureWhite (VW) and RGDA8430-DM (8430). VW is a stiff and strong prototyping plastic. See Stratasys, Vero for Stratasys J55. https://www.stratasys.com/siteassets/materials/materials-catalog/polyjet-materials/verovivid/mds_pj_vero_for_j55_0320a.pdf. (Accessed May 2023). 8430 is a digital mixed print material composed of a mixture of VW and Agilus30, a rubber-like material. See Stratasys, Agilus30 PolyJet Rubberlike Material. https://www.stratasys.com/globalassets/materials/materials-catalog/polyjet-materials/agilus30/mds_pj_agilus30_0121b.pdf. (Accessed May 2023). The tensile properties of VW and 8430 were measured in uniaxial tension using custom tensile dogbones. The test setup was identical to those used by Brown et al. and Young et al. in previous studies of ILMs. See N. K. Brown et al., Mater. Design 233, 112272 (2023); and B. Young et al., Mater. Design 227, 111798 (2023). The flexural properties were measured in 3-point bending using ASTM standard D790 sample geometries. The elastic material properties are shown in Table 1 with both experimental and published values where the latter are given in the literature.

TABLE 1
Published and experimentally measured elastic properties of testing materials.

| | | | | | Ultimate | | |
|---|---|---|---|---|---|---|---|
| | | | | Tensile | Tensile | Flexural | |
| | | Young's | Flexural | Yield | Strength | Yield | Poisson's |
| | | Modulus | Modulus | Stress | (UTS) | Stress | Ratio (ν) |
| | | (E) [GPa] | [GPa] | [MPa] | [MPa] | [MPa] | [—] |
| Published | VW | 2.2-3.0 | 2.0-2.5 | 40-55 | — | 70-85 | — |
| | 8430 | — | — | — | — | — | — |
| | Agilus30 | — | — | 2.1-2.6 | — | — | — |
| Experimental | VW | 2.1 ± | 1.9 ± | 46 ± | 52 ± | 62 ± | 0.40 ± |
| | | 0.079 | 0.19 | 0.99 | 0.64 | 6.8 | 0.080 |
| | 8430 | 1.5 ± | 1.6 ± | 32 ± | 36 ± | 49 ± | 0.45 ± |
| | | 0.072 | 0.092 | 0.60 | 0.58 | 5.3 | 0.034 |
| | Agilus30 | — | — | — | — | — | — |

### Interlocking Metamaterial Design

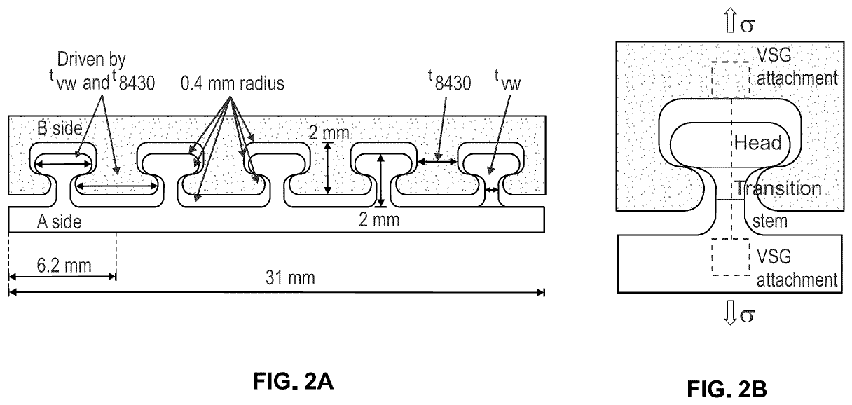

As shown in FIG. 1, the sliding T-slot profile uses crossbar-like unit cells that interact across the interface when placed under tensile load. Joints composed of large arrays of T-slot unit cells are significantly stronger relative to single unit cells. See B. Young et al., Mater. Design 227, 111798 (2023). Therefore, a 1×5 T-slot unit cell array was experimentally tested to benefit from the strengthening due to unit cell interaction. The unit cell, defined in FIG. 2a, was 6.2 mm wide (in the \vec{x} direction) by 5.2 mm deep (in the \vec{y} direction). The stem thickness was varied with an inverse relationship between VW and 8430 stem thicknesses t_{VW} and t₈₄₃₀, respectively, following Eqn. (1).

$$4.2 mm = {t}_{V W} + {t}_{8430} \qquad ( 1 )$$

The height of individual “T” features and the radii of all curvatures were fixed at 2 mm and 0.4 mm, respectively, and the head and transition section width were driven by the stem thickness with a matching increase and decrease in width, as shown in FIG. 2b. The overall width of the array was fixed.

### Parametric Optimization

The parametric optimization used herein was a finite element analysis (FEA)-based geometry optimization. It was implemented via Plato which leverages the Sierra structural dynamics finite element code. The optimization goal was to maximize the force sustained by the joint before the yield stress was exceeded in either material. Simultaneously exceeding the yield stress in both materials of the ILM theoretically maximizes the force carried by the joint; therefore, the optimization objective was to find a geometry configuration that results in both materials reaching their respective yield stresses at the same time under a given load. The objective value at each iteration was calculated by taking the absolute value of the difference of the stress ratios which are the ratios of the maximum stress to the yield stress for each material, see Eqn. (2).

$$Objective = \frac{{σ}_{max , A side}}{{σ}_{yield , A side}} - \frac{{σ}_{max , B side}}{{σ}_{yield , B side}} \qquad ( 2 )$$

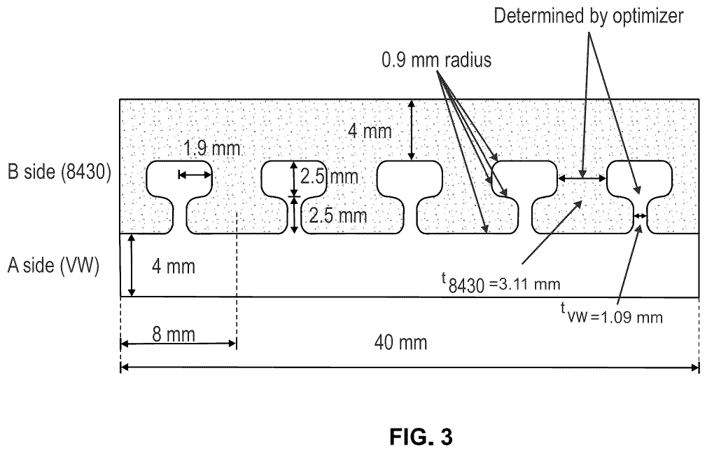

Previous studies on ILMs with T-slot unit cell profiles found that, when tested in uniaxial tension, failure occurred primarily in the T-slot stem rather than in the T-slot heads or transition regions between stem and head shown in FIG. 2b. See O. Bolmin et al., J. Mater. Sci. 58 (1), 411 (2023); B. Young et al., Mater. Design 227, 111798 (2023); and N. K. Brown et al., Mater. Design 233, 112272 (2023). Therefore, the stem thickness was the geometric component that was parametrically modified to keep computational costs low. The T-slot height and radii were held constant, and the head width was driven by the stem thickness dimension of the mating metasurface. Due to FEA constraints, the A and B side geometries must be in full contact along interface. FIG. 3 shows a diagram of the optimization geometry obtained by PO. The FEA model also only used uniaxial tension elastic properties with assumed isotropy to maintain model simplicity, see Table 1.

### Experimental Methods

Tensile tests were performed using the same approaches previously developed for mechanical characterization of ILMs. See O. Bolmin et al., J. Mater. Sci. 58 (1), 411 (2023); B. Young et al., Mater. Design 227, 111798 (2023); and N. K. Brown et al., Mater. Design 233, 112272 (2023). Mechanical testing of ILMs was conducted under displacement control at 0.01 mm/s. The force was normalized to stress using a consistent ILM footprint of 5.2 mm deep by 31 mm wide, as shown in FIG. 2a. To standardize the stress-strain curves and mitigate variable engagement effects, all curves were shifted to a pre-stress of 0.2 MPa at 0% strain. The tensile strength of each ILM was assessed by measuring both the yield strength and ultimate tensile strength (UTS) of the joint. ILM yield strength was determined using a 0.2% strain offset and Young's modulus, with the intersection point representing the ILM's yield stress. Yield measurements pertain to the ILM joint as a whole, rather than the individual constitutive materials, which exhibited localized plasticity in the T-slots prior to the ILM yielding. This was due to stress concentrations at the radii, exacerbated by the pre-stress. This approach to assessing the yield strength was necessary due to variability in T-slot engagement and was applied consistently across all samples, ensuring valid comparisons between T-slot geometries. The UTS provided an additional comparison point for joint strength. A minimum of five tensile tests were performed for each ILM. The unit cell geometries examined are listed in Table 2. Baseline tests were also conducted to evaluate the strengths of VW reference ILM and 8430 reference ILM joints.

TABLE 2
A summary of ILM geometries for experimental testing which
is organized by stem thickness ratio between B and A sides.

| | A Side | | B Side | | | Ratio of B |
|---|---|---|---|---|---|---|
| | | Stem | | Stem | Stem | to A Side |
| Geometry | | Thickness | | Thickness | Thickness | Stem |
| Name | Material | (t_{VW}) [mm] | Material | (t₈₄₃₀) [mm] | Ratio | Thickness |
| VW | VW | 2.1 | VW | 2.1 | 1:1 | 1 |
| Reference | | | | | | |
| ILM | | | | | | |
| 6:1 | VW | 3.6 | 8430 | 0.6 | 6:1 | 0.17 |
| VW:8430 | | | | | | |
| 2.85:1 | VW | 3.11 | 8430 | 1.09 | 2.85:1 | 0.35 |
| VW:8430 | | | | | | |
| 1:1 | VW | 2.1 | 8430 | 2.1 | 1:1 | 1 |
| VW:8430 | | | | | | |
| 1:2.85 | VW | 1.09 | 8430 | 3.11 | 1:2.85 | 2.85 |
| VW:8430 | | | | | | |
| 1:6 | VW | 0.6 | 8430 | 3.6 | 1:6 | 6 |
| VW:8430 | | | | | | |
| 8430 | 8430 | 2.1 | 8430 | 2.1 | 1:1 | 1 |
| Reference | | | | | | |
| ILM | | | | | | |

To refer to these ILMs, a convention of stem thickness ratio followed by material combination was selected, e.g. 1:2.85 VW: 8430 refers to the stem thickness ratio and material combination of the optimized geometry. The other asymmetric ILMs covered a range of stem thickness ratios to capture the overall trend of ILM joint behavior. VW and 8430 reference ILMs were also tested for comparison with symmetric geometries and matching stem thicknesses.

### Computational ILM Geometry Optimization

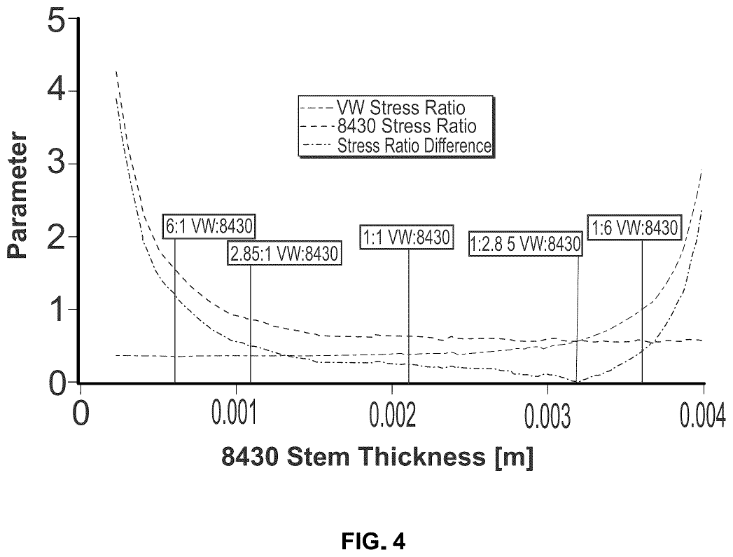

The stress ratios were equal at an 8430 stem thickness of 3.11 mm; this gives an objective value (Eqn. (2)) of zero, as shown in FIG. 4. Outside of the optimized stress ratio, the objective curve is relatively flat in the center with steep slopes near the edges. The flat section at the center suggests that only minor differences will be present in the tensile performance of all ILM geometries with these 8430 stem thicknesses (i.e., ˜ 1 to 3.6 mm). The steep slopes of the objective at each end suggests a rapid divergence from the goal of simultaneous yielding of each side of the joint which will result in one of the sides of the ILM yielding far before the other. The limited complexity resulted in differences with experimentally measured values such as T-slot head angular deflection. However, FEA was only considered as a general guide for expected ILM experimental tension testing results, so the limitations are expected and not considered impactful on the final results.

### Experimental Stress-Strain Behavior

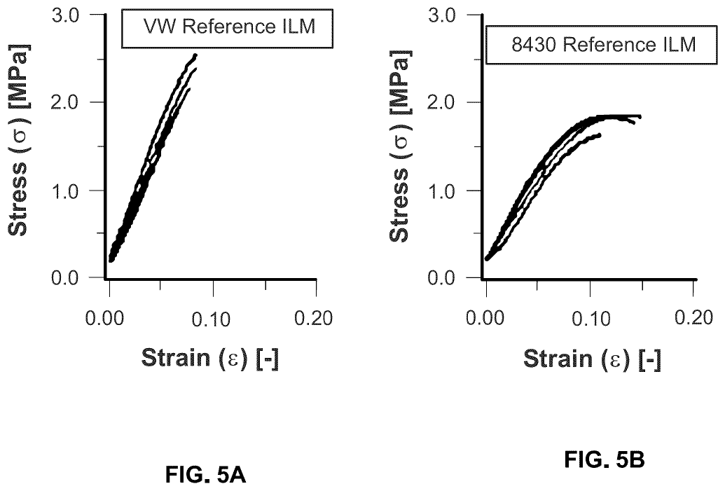

To provide baseline comparisons, the tensile strengths of ILM joints made entirely from VW and 8430, respectively, with symmetric T-slot geometries were measured. The yield strength of VW ILM joints was 64.5% greater than 8430 ILM joints, as shown in FIGS. 5a and 5b. In contrast, 8430 ILM joints exhibit 67.6% greater ductility than those fabricated from VW.

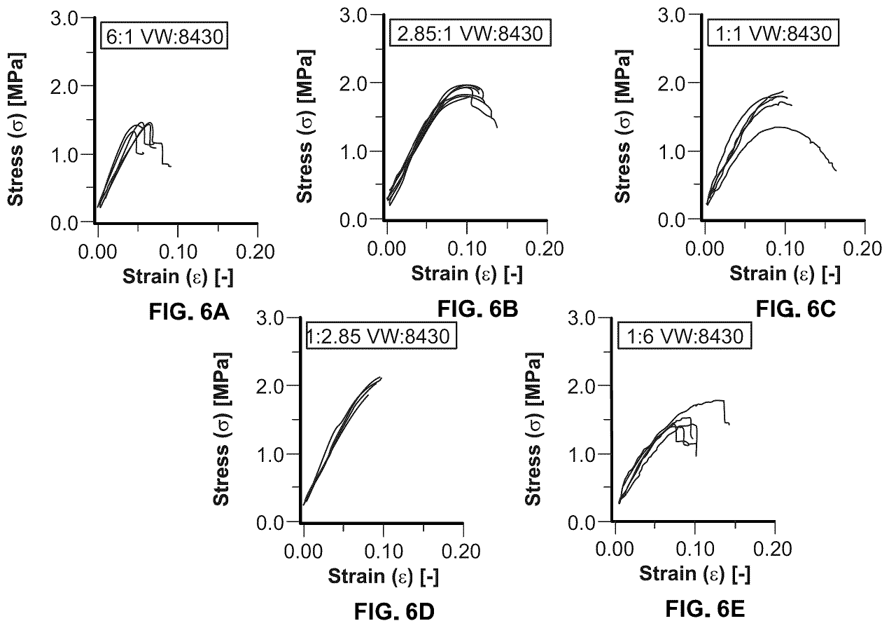

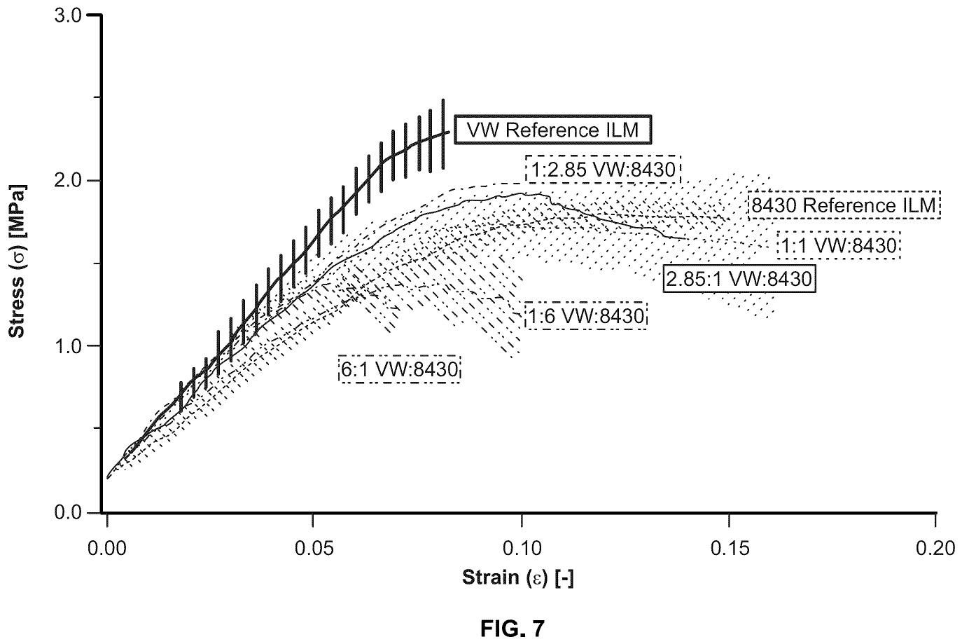

Next, dissimilar material ILM geometries were elongated to failure in tension. Plots of stress versus strain from these tests are shown in FIGS. 6a-6e. 1:2.85 VW: 8430, the optimized geometry, exhibited the highest yield strength of any joint, excluding the VW reference joint. Notably, it exceeded the yield strength of the 8430 ILM joint. Some test to test variability was observed, as seen particularly FIGS. 6c and 6e. To assist comparison between these geometries, mean stress-strain curves from each plot are shown in FIG. 7.

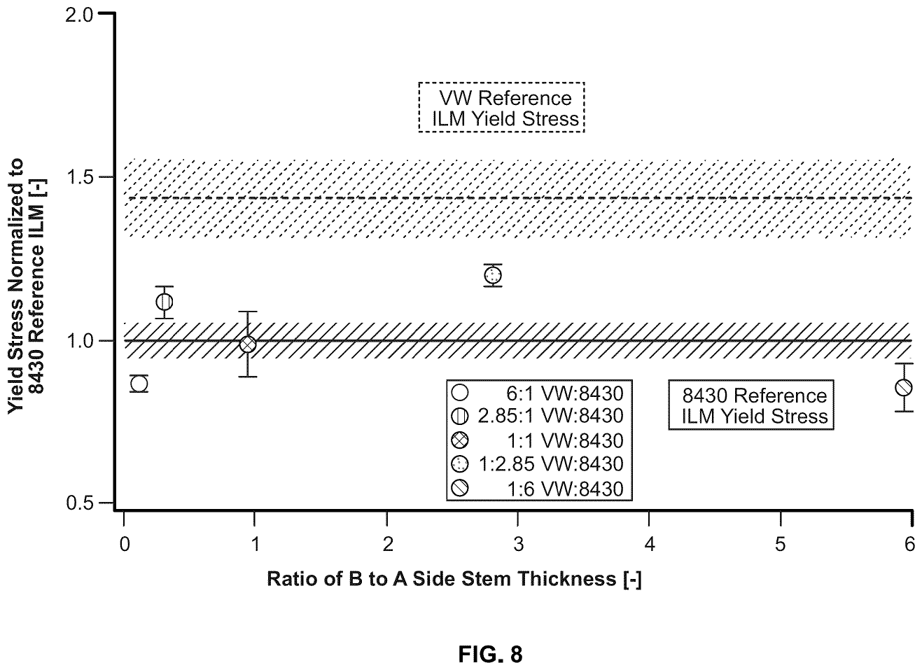

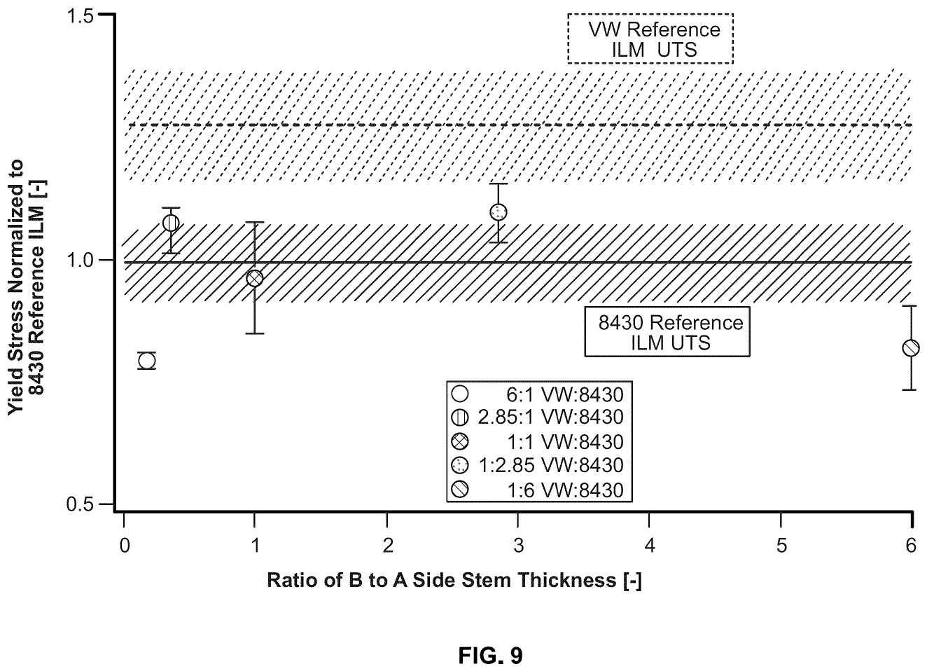

FIGS. 8 and 9 show plots of the yield strength and UTS of each joint normalized to that of the 8430 ILM that summarize the tensile performance of all ILM joints. The 1:1 VW: 8430 ILM matches the joint yield strength of the 8430 reference ILM. Both the 1:2.85 VW: 8430 and 2.85:1 VW: 8430 ILMs exceed the joint yield strength of the 8430 reference ILM. The UTS results exhibit larger standard deviations than the yield strength results, but the 1:2.85 VW: 8430 also exceeds the UTS of the 8430 reference ILM.

### In-Situ Imaging Results

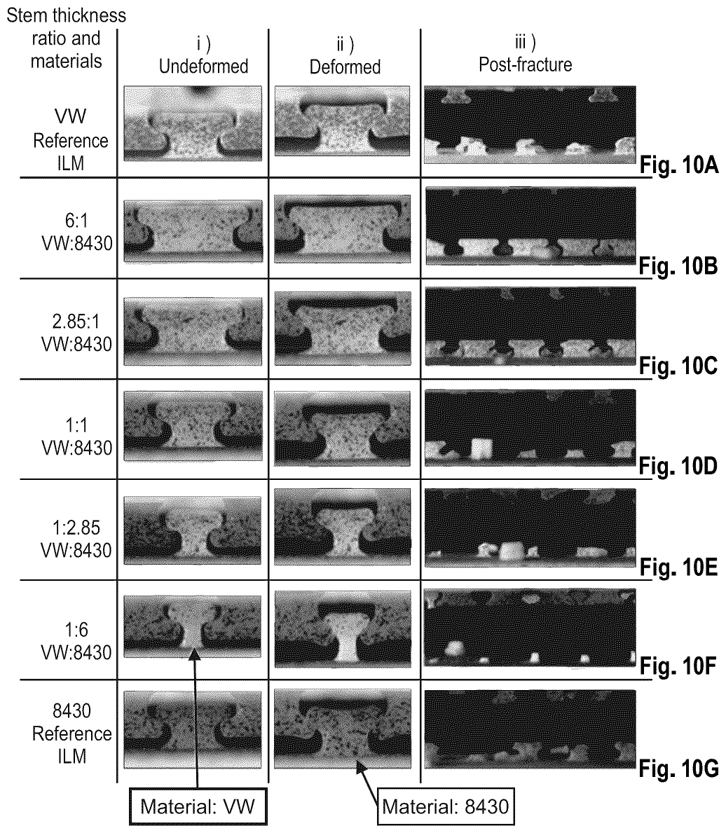

FIGS. 10a-10g show a series of in-situ grayscale images for each ILM T-slot geometry, captured in three distinct states: undeformed, deformed, and post-fracture. These images offer a comprehensive visual analysis of the deformation and fracture behavior of each ILM. Significant differences were observed in the failure modes of the specimens. The fracture locations were extracted from col. iii and are summarized in Table 3.

TABLE 3
ILM fracture locations for all geometries tested.

| | Fracture location | |
|---|---|---|
| Geometry | A side (VW) | B side (8430) |
| 6:1 VW:8430 | — | Stem |
| 2.85:1 VW:8430 | — | Transition |
| 1:1 VW:8430 | Stem | Stem |
| 1:2.85 VW:8430 | Stem | Stem |
| 1:6 VW:8430 | Stem | — |

“—“ indicates no fracture occurred.

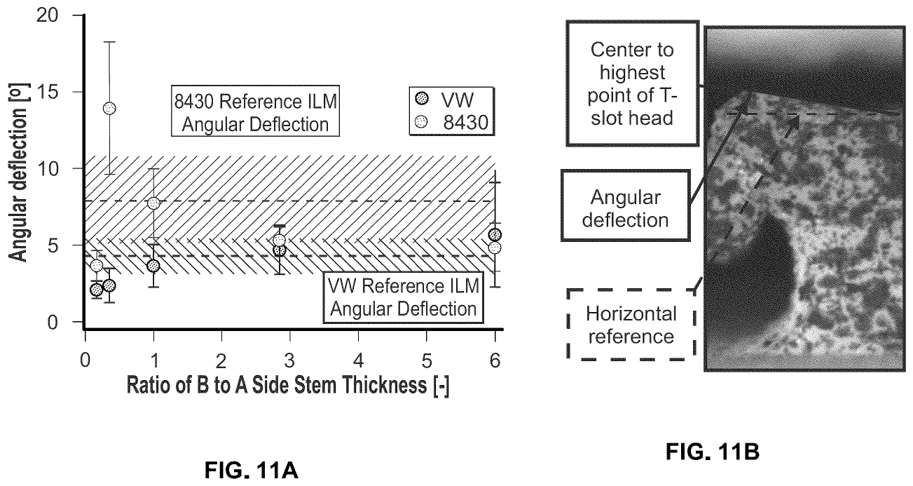

To quantitatively evaluate the deformation of the T-slot heads, FIG. 11 presents angular deflection measurements of the T-slot head of each design immediately before failure. A larger angular deflection corresponds to greater flexural stress in the T-slot heads. Most T-slot angular deflections are similar on both sides of the joint, with one notable exception: the 2.85:1 VW: 8430 (ratio of B to A side stem thickness of 0.35). Specifically, the 8430 side of the 2.85:1 VW: 8430 joint exhibits an exceptionally high angular deflection of 13.9°, indicating a significant amount of flexural stress, surpassing that observed in any other geometry.

The above describes the mechanical properties of ILM joints between dissimilar materials, focusing on the role of unit cell geometry and isotropic elastic properties. These properties demonstrate the effectiveness of ILMs to join dissimilar materials, showcasing both symmetric and asymmetric geometries. ILMs can be engineered to achieve joint strengths that surpass those of the weaker constituent material, with asymmetric geometries offering significant enhancements in joint yield strength compared to symmetric geometries. Understanding the factors that control these mechanical properties is crucial for designing robust and reliable joints in systems where dissimilar materials are used. While the above example describes joining of two specific dissimilar materials, the interactions of stiffer, stronger materials and compliant materials joined using ILMs are considered universal to a wide range of engineering applications, as described below.

### Dissimilar Material Joints with ILMs—Baseline Symmetric Joints

The symmetric ILM joint, i.e. the 1:1 VW: 8430 configuration, matched the yield strength of the 8430 reference ILM. This demonstrates that ILMs can join dissimilar materials without compromising joint strength. This result implies that designers can use symmetric ILMs to join dissimilar materials, ensuring that robust joints can be made between dissimilar materials.

### Optimizing ILM Performance Via Isotropic Yielding

The 1:2.85 VW: 8430 ILM geometry, optimized based on isotropic elastic properties, exhibited the largest yield strength and UTS. Optimization produced a design with a smaller stem thickness for the stiffer VW material compared to the 8430 material. The fracture patterns within the T-slot stems suggest that simultaneous yielding and failure in both materials contributed to enhancing the tensile performance of this joint relative to all others. This demonstrates the potential of tailored ILM geometries to optimize joint performance.

### The Effects of Bending on ILM Strength

The strength of ILMs generally decreased with deviations from the optimal unit cell geometry, as suggested by parametric optimization results shown in FIG. 4. However, the 2.85:1 VW: 8430 ILM geometry exhibited a similar yield strength and UTS to the optimized geometry. This was somewhat surprising, as the weaker material, 8430, had a significantly thinner stem than the stronger VW material. Intuitively, this joint might be expected to be weaker compared to the 1:1 VW: 8430 design. However, this design performed relatively well.

Table 1 shows that, for both materials, the flexural yield strength is greater than the tensile yield strength. Consider now FIG. 11. Larger angular deflections indicate increased flexural loading, with the highest deflection observed on the 8430 side of the 2.85:1 VW: 8430 ILM. Specifically, the geometry of this unit cell resulted in significant localized bending within the crossbars of the T's. The significant load carried in bending by the crossbars, i.e. in flexion, thus likely enhanced the joint's strength relative to that of the 1:1 VW: 8430 design. Flexural loading was not considered in the parametric optimization, which precluded identification of this mechanism initially.

These results indicate that both tensile and flexural material properties play a significant role in the tensile strength of ILMs consisting of T-slots. Further improvements could be realized by adopting advanced optimization methods, such as distributed-parametric optimization and multimaterial topology optimization frameworks. See Y. Muramatsu and M. Shimoda, Struct. Multidiscip. Optim. 59 (6), 1915 (2019); M. Maoz et al., Sustainability 11 (11), 3186 (2019); R. D. Kundu and X. S. Zhang, Compos. Struct. 320, 117041 (2023); X. Huang and W. Li, Comput. Methods Appl. Mech. Eng. 386, 114114 (2021); and D. Li and I. Y. Kim, Struct. Multidiscip. Optim. 58 (3), 1081 (2018). These methods can help explore the full potential of ILMs for joining dissimilar materials, e.g. maximizing both stiffness and strength.

Localized plasticity can also play a significant role in the performance of ILMs. While not considered herein, localized yielding in the T-slot radii could cause work hardening in these regions, increasing the joint's yield strength. Plasticity could be leveraged in ILM designs to create joints with superior mechanical properties. Different materials and geometries can be used to optimize the balance between elastic and plastic deformation.

The present invention has been described as dissimilar materials joining via interlocking metasurfaces. It will be understood that the above description is merely illustrative of the applications of the principles of the present invention, the scope of which is to be determined by the claims viewed in light of the specification. Other variants and modifications of the invention will be apparent to those of skill in the art.

1. Interlocking metasurfaces, comprising a first metasurface of a first material having a first array of mechanically interlocking surface features that mate with a second metasurface of a second material having a second array of mechanically interlocking surface features.

2. The interlocking metasurfaces of claim 1, wherein the interlocking metasurfaces are configured such that the first and second materials reach their respective yield stresses at the same time when a tensile load is applied to the interlocking metasurfaces.

3. The interlocking metasurfaces of claim 1, wherein the mechanically interlocking surface features of at least one of the first or second metasurfaces comprise a polymer, ceramic, or metal.

4. The interlocking metasurfaces of claim 1, wherein the first metasurface comprises a first array of interlocking T-shaped features on a first supporting surface and the second metasurface comprises a second array of interlocking T-shaped features on a second supporting surface, wherein the interlocking T-shaped features are configured to provide a T-slot.

5. The interlocking metasurfaces of claim 4, wherein the interlocking metasurfaces are configured to provide asymmetric interlocking metasurfaces, wherein at least one geometric component of the interlocking T-shaped features of the first and/or second array is modified such that the first and second materials reach their respective yield stresses at the same time when a tensile load is applied to the interlocking metasurfaces.

6. The interlocking metasurfaces of claim 1, wherein the interlocking T-shaped features are configured to provide a snapping T-slot.

7. The interlocking metasurfaces of claim 1, wherein at least one of the first or second array of the mechanically interlocking surface features comprises arrow-like features protruding off of a supporting surface.

8. The interlocking metasurfaces of claim 7, wherein the arrow-like features comprise a split arrowhead.

9. The interlocking metasurfaces of claim 7, wherein the arrow-like features comprise a locked split arrowhead.
